(19) United States
(12) Patent Application Publication
(10) Pub. No.: US 2004/0142075 A1
(43) Pub. Date: Jul. 22, 2004

(54) Sushi tray and method of using

(76) Inventors: Laura Ellis, Sun Valley, CA (US); Mary De Martinis, Sun Valley, CA (US)

Correspondence Address: Daniel L. Dawes, MYERS, DAWES & ANDRAS LLP, 19900 MacArthur Blvd, Ste 1150, Irvine, CA, 92612, US

(21) Appl. No.: 10/348,501

(22) Filed: Jan. 21, 2003

(51) Int. Cl. A23B 4/00

(52) U.S. Cl. 426/115

(57) ABSTRACT

A sushi package (10) holds the several rows (13, 15, 17) of sliced sushi (20) in an overlapping propped configuration. The sushi package (10) comprises an underlying tray (25) and an overlying cover and (30). While sushi packages of the past have typically displayed sushi in a relatively flat orientation, the instant package (10) presents the sushi (20) in a much more compact, shingled configuration that greatly enhances the appearance of the sushi (20). Furthermore, the overlapping shingled configuration places respective upper edges of the slices of sushi (20) in close proximity to an underside of the cover (30). This compact configuration further advantageously inhibits movement of the sushi slices (20) during storage and shipping.

### BACKGROUND OF THE INVENTION

1. Field of the Invention

The instant invention lies generally in the field of sushi packages for displaying and selling sushi, and more specifically in the field of compact packages of partially overlapped sushi for an excellent aesthetic appeal and more restrictive inner package structure for inhibiting movement of slices of rolled sushi.

2. Description of the Prior Art

Sushi packages of the past have trays that display sushi in a relatively flat orientation. Even when sushi is propped for display, the angle at which the sushi is tilted is very small. Furthermore, the individual slices of sushi in the past have been displayed and sold on trays in non-overlapping relation to each other. In this way the packages and trays of the past are deficient in bunching slices of sushi together in an overlapped or shingled configuration.

As a result of the non-overlapped relationship of slices of sushi, the packages of the past have been deficient in providing a package that has sushi slices that are compact in a direction along a plane of the tray. Furthermore, the slices of sushi in the packages of the past generally lie relatively low in the packages and are therefore spaced from a lower inner surface of the cover. In this way, the packages of the past are also deficient in providing packages that are compact in the height direction.

The sushi packages of the past have props that tilt the slices of sushi slightly for improved viewing by a customer. However, the sushi packages of the past are deficient in providing heights, angular relationships, and spacing between front and rear faces of the props to facilitate overlapping several rows of slices of sushi.

### BRIEF SUMMARY OF THE INVENTION

The instant invention overcomes these deficiencies and fills a need for a compact, aesthetically improved package of sushi. The props have relatively steeply inclined surfaces, yet have heights that are low enough to permit overlapping of upper portions of a plurality of slices of sushi of one row on lower portions of a plurality of slices of sushi on another adjacent row. Thus, the package of the instant invention provides a package that is compact in both horizontal and vertical directions. Aesthetically, the result of the more compact instant sushi package has the advantage of providing a “bunched” look as opposed to the sparse appearance of past packages. This “bunched” look is more appealing since it conveys a message of plenty to the customer.

In summary the invention comprises a sushi package having a tray generally defining a plane in a regularly horizontal position of use. The tray has an upper surface and a lower surface. The upper surface has a plurality of wedge sectioned props each having at least one of a front surface and a rear surface. The props extend to heights measured from a lowest point to a highest point of the respective props and the props extend axially from side to side. In this way, the plurality of wedge sectioned props form rows with a respective wedge sectioned prop between adjacent ones of the rows. In order to provide an aesthetic presentation of sushi on the tray, the rows are spaced from each other a distance less than or equal to 1½ of the height of the prop between the rows. This spacing and relative height provides for relative positioning of multiple rows of sushi in an overlapping and tilted display by propping a lower portion of a first cut surface of a first slice of sushi on the upper surface of the tray, and an upper portion of the first cut surface of the first slice of sushi on a lower portion of a second cut surface of a second slice of sushi. The invention also typically includes a transparent cover supported on the tray.

In one aspect of the instant sushi package, the tray further comprises a front, a back, first lateral side, and a second lateral side. The upper surface and the lower surface each extend between the front, back, and sides. A raised edge extends along the front, back, and sides and surrounds a major portion of the upper surface. At least one channel extends longitudinally in a front to back direction between the props and the raised edge. The cover further comprises a front, a back, a first lateral side, and a second lateral side. An upper surface and a lower surface of the cover each extend between the front, back, and sides of the cover. The lower surface is proximate to the slices of sushi to inhibit movement of said slices of sushi during storing and shipping in a covered configuration. To accomplish the proper positioning of the cover with respect to the sushi, the cover has a downwardly protruding wall engaging the tray and supporting the cover on the tray to protect the slices of sushi supported on the props in the covered configuration.

In another aspect of the invention, the channel is a first channel adjacent to the first lateral side, and the upper surface of the tray further comprises a second channel adjacent to the second lateral side. The first and second channels have recesses forming corresponding downward protrusions on the lower surface of the tray. The upper surface of the cover further comprises depressions for receiving corresponding downward protrusions on a lower surface of another tray. In this way, a plurality of the packages can be securely stacked with each of the plurality of trays matingly fitting on top of each of the plurality of covers and the downwardly extending protrusions on the lower surfaces of the trays engaging in respective depressions on the upper surfaces of the covers. Since all of the packages are the same for a given stack, the packages can be placed in any order in their covered configurations.

In still another aspect of the invention, the sushi package comprises a paper label circumscribing the tray and the cover. The paper label is attached to generally flat faces formed on the lower surface of the tray in order to aid in holding the cover on the tray.

A method of displaying in accordance with the instant invention comprises propping a lower portion of a first cut surface of a first slice of sushi on a surface of a tray and an upper portion of the first cut surface of the first slice of sushi on a lower portion of a second cut surface of a second slice of sushi. This is facilitated by the structure of the tray including props as set forth above. Another step in the method of displaying is that of covering the first and second slices of sushi with a transparent cover proximate to respective upper edges of the slices of sushi so that little or no movement of the sushi occurs during storing and shipping.

In one aspect of the method, the first slice of sushi is one of a plurality of similar slices of sushi on a first row, and the second slice of sushi is one of a plurality of similar slices of sushi on a second row. Furthermore, the first and second rows are first and second rows of four or more rows.

In another aspect of the method, the step of propping further comprises supporting generally ½ of the cut surface of the first slice of sushi on the second cut surface of the second slice of sushi.

A still further aspect of the method comprises covering the tray with the cover and providing the cover such that an upper-most inner surface of the cover is at a predetermined position relative to the lower-most surface of the tray. Preferably, the predetermined position is in the range from two to three times the height of the props.

A still further aspect of the method of displaying includes stacking the plurality of like packages so that when a top package is removed the contents of the next subjacent package is automatically displayed in like manner to the top package before it was removed.

Another aspect of the method of displaying includes removing and inverting the cover, inserting the tray into the cover, and snap fitting the tray into the cover for a serving display configuration.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The invention can be better visualized by turning now to the following drawings wherein like elements are referenced by like numerals.

### BRIEF DESCRIPTION OF THE DRAWINGS

FIG. 1A is a perspective view of a package including several rows of sushi in accordance with the instant invention;

FIG. 1B is a perspective view similar to FIG. 1A, but from a slightly different angle and showing additional details;

FIG. 1C is a schematic side view of a stack of packages in accordance with the instant invention;

FIG. 2 is a top view of the package having specifics to a first embodiment;

FIG. 3 is a sectional view taken along lines 111-111 of FIG. 2;

FIG. 4 is a sectional view taken along lines IV-IV of FIG. 2;

FIG. 5 is a sectional view of details of a second configuration in the encircled region V of FIG. 4;

FIG. 6 is a top view of an encircled region VI of FIG. 2 having details to a second embodiment;

FIG. 7 is a sectional view taken along lines VII-VII of FIG. 6;

FIG. 8 is a top view similar to FIG. 6 illustrating a third embodiment of region VI of FIG. 2; and

FIG. 9 is a sectional view taken along lines IX-IX of FIG. 8.

The invention and its various embodiments can now be better understood by turning to the following detailed description of the preferred embodiments which are presented as illustrated examples of the invention defined in the claims. It is expressly understood that the invention as defined by the claims may be broader than the illustrated embodiments described below.

### DETAILED DESCRIPTION OF THE PREFERRED EMBODIMENTS

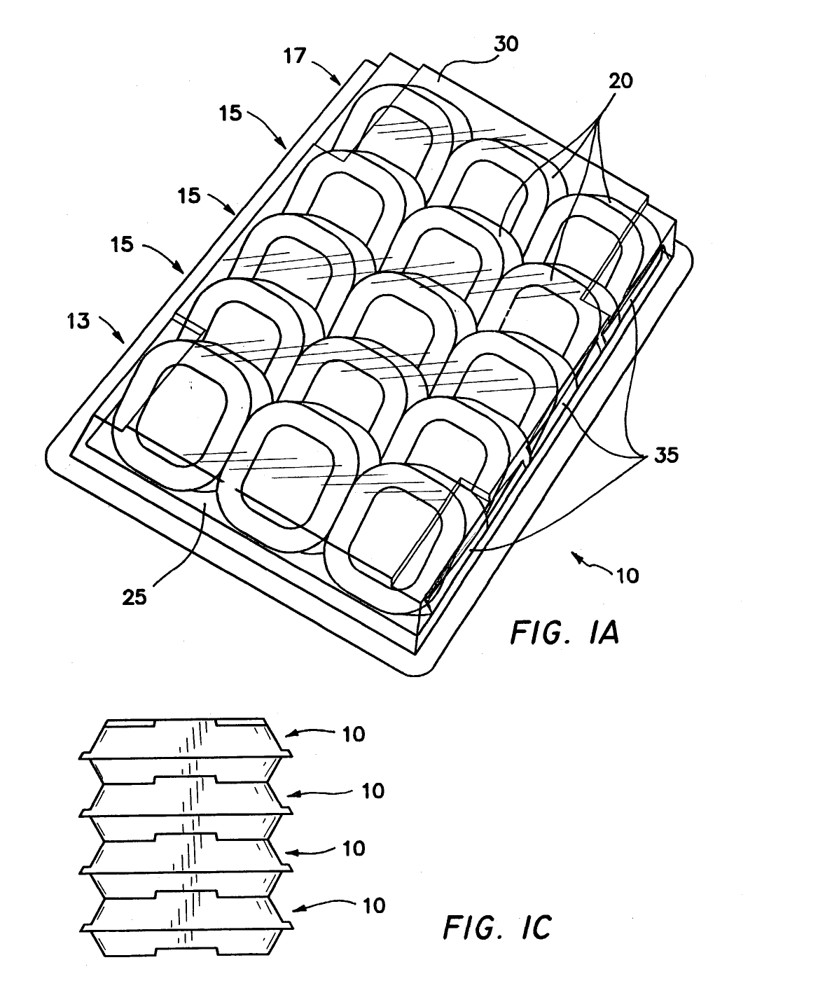

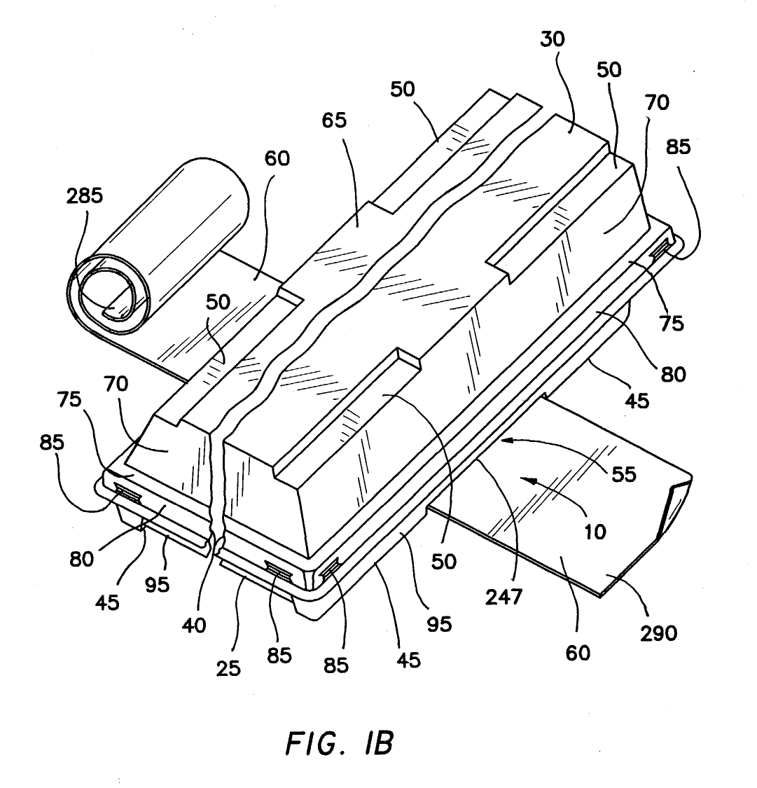

As shown in FIG. 1A, a sushi package 10 holds the several rows 13, 15, 17 of sliced sushi 20 in an overlapping propped configuration. As shown, the sushi package 10 comprises an underlying tray 25 and an overlying cover 30. While sushi packages of the past have typically displayed sushi in a relatively flat orientation, the instant package 10 presents the sushi 20 in a much more compact, shingled configuration that greatly enhances the appearance of the sushi 20. Furthermore, the overlapping shingled configuration places respective upper edges of the slices of sushi 20 in close proximity to an underside of the cover 30. This compact configuration further advantageously inhibits movement of the sushi slices 20 during storage and shipping.

It should be noted that sushi comes in a variety of shapes and sizes. The instant package 10 is particularly for the type of sushi that is pre-rolled and simply cut into slices for its final presentation and consumption. As such, the sushi slices 20 are generally round disks or flat squares with rounded corners. While the sizes of the slices 20 can be varied greatly without departing from the spirit and scope of the invention, the sushi slices 20 are generally bite sized or slightly larger. As shown in FIG. 1A, packets 35 of soy sauce or other toppings can be included in a space provided within the package 10 as further discussed below.

FIG. 1B is a perspective view showing more details of the package 10. As indicated by the broken lines 40, the tray and cover can be made of any of a variety of widths without departing from the spirit and scope of the invention. Likewise, the package can be made to have any of a variety of lengths. The tray 25 comprises downward extending protrusions 45. The cover 30 comprises complementary depressions 50 so that a plurality of packages 10 can be securely stacked one on top of the other. The protrusions 45 on the tray 25 of a next superjacent package engage in the depressions 50 on the cover 30 of the package 10 on which the superjacent package is stacked. In this way, several packages can be stacked in a non-slip condition as illustrated in FIG. 1C. A gap 55 between protrusions 45 on the tray 25 provides a slot for receiving a paper label 60. The label 60 is wrapped around the package 10 in a belt like manner. As can be appreciated, the printing on the label that is to be most prominently visible is positioned in the uninterrupted portion 65 of the cover 30.

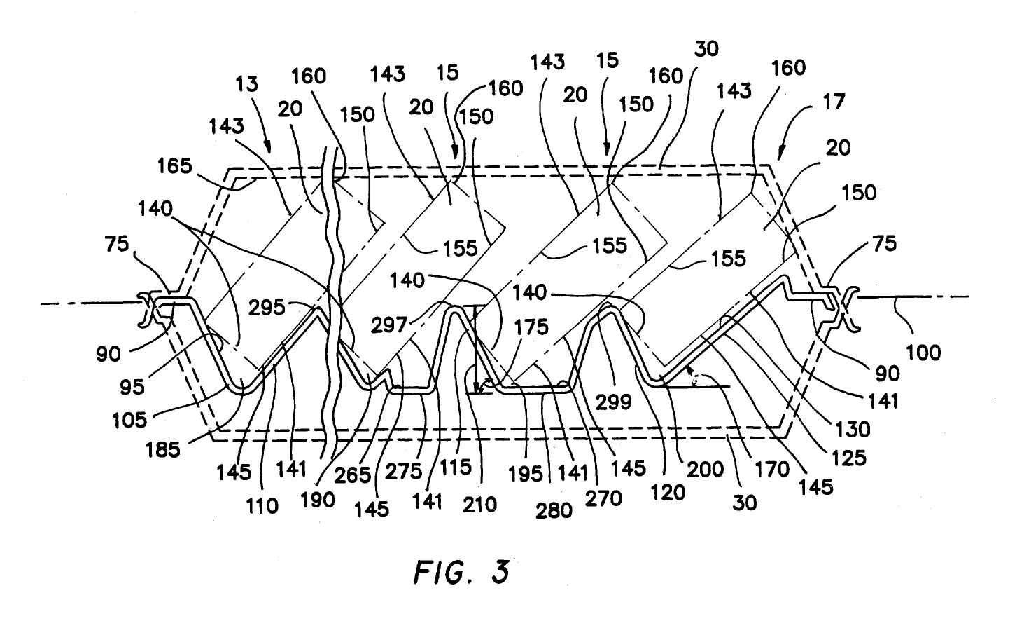

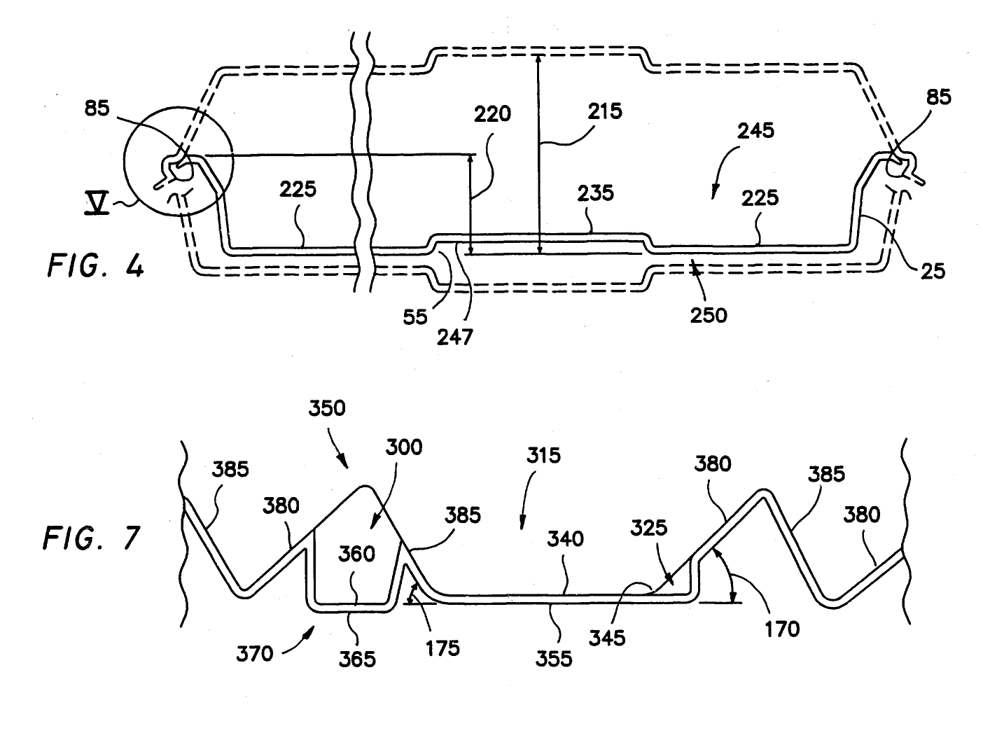

The cover 30 is supported on the tray 25 by a downwardly protruding wall 70 of the cover 30. The downwardly protruding wall 70 comprises an outwardly protruding flange 75 and a further downwardly extending wall 80 including inwardly protruding tabs 85. As shown in FIG. 3, the outwardly protruding flange 75 of the cover 30 rests on an outwardly extending lip 90 of a raised edge 95 of the tray 25. In the closed or covered configuration, tabs 85 engage under the lip 90 of the tray 25 in a snap fit relation and hold the cover in place on the tray as shown in FIGS. 1B and 4.

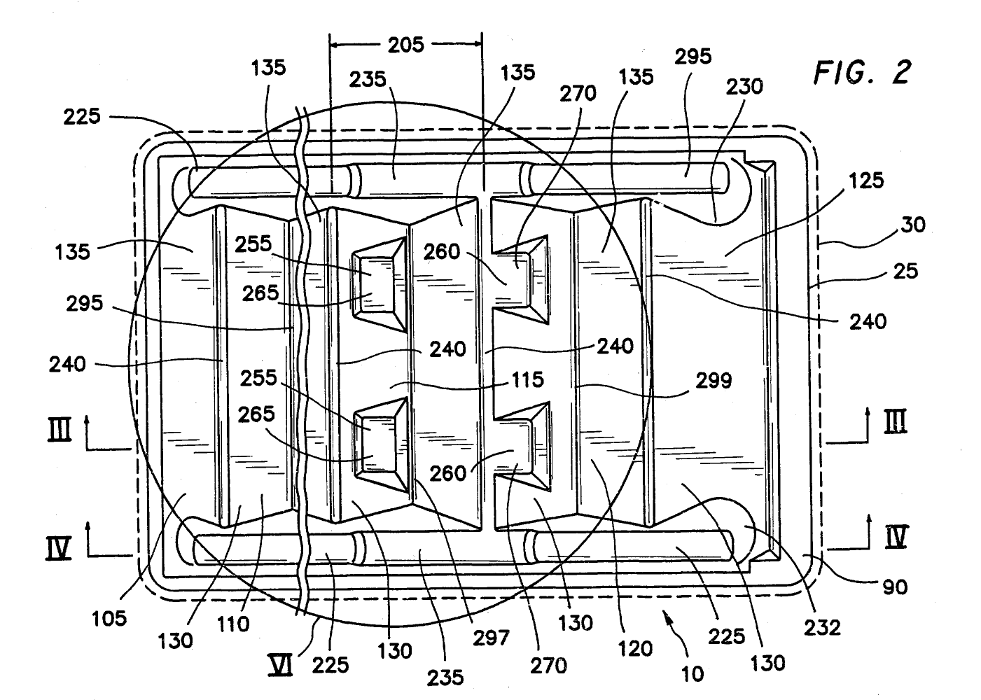

FIG. 2 is a top view of an empty package 10. As indicated by the dashed line surrounding the tray 25, the cover 30 is transparent and extends slightly outwardly in all directions in a plane 100 of the tray 25. The plane 100 of the tray 25 is generally defined by the outwardly extending lip 90.

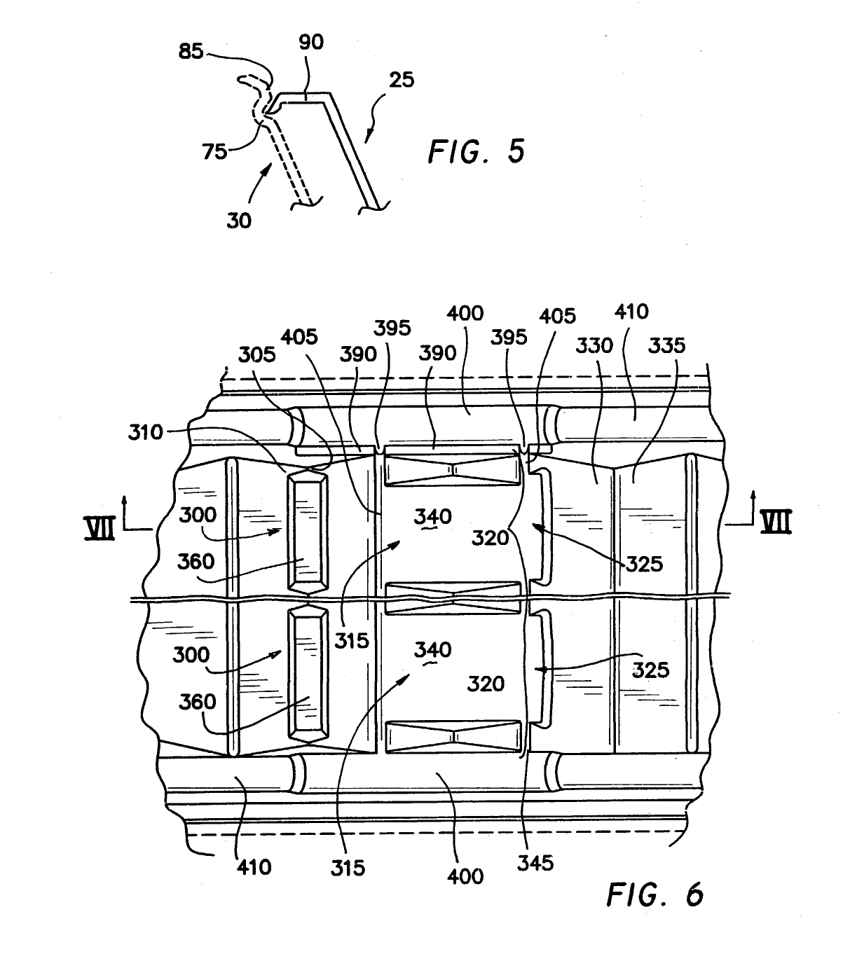

FIGS. 3 and 4 are sectional views taken in a widthwise direction of the package 10 as indicated by lines III-III and IV-IV of FIG. 2. As shown in the sectional views of FIGS. 3 and 4, the cover 30 rests on top of outwardly extending lip 90 in the covered configuration, and alternatively is placed below the tray 25 in an uncovered, serving configuration. As shown in FIGS. 4 and 5, the tabs 85 engage generally above the outwardly protruding lip 90 of the tray 25 in the serving configuration. The outwardly extending flange 75 of the cover 30 engages under the outwardly protruding lip 90 in this serving configuration, and the tray is received in the cover in a snap fit relation as shown in FIGS. 4 and 5.

As shown in FIGS. 2 and 3, the wedge sectioned props 105, 110, 115, 120, 125 support slices of sushi 20 in an overlapping propped configuration. Each of the props has at least one of a front face 130, or a rear face 135. Intermediate props 110, 115, 120 have both front and rear faces 130, 135. As shown in FIG. 3, the rear faces 135 support a lower non-cut portion 140 of the sushi slices 20. The front faces 130, on the other hand, support respective first lower portions 145 of first cut surfaces 141 of the slices of sushi 20. A first upper portion 150 of the first cut surface 141 of each slice of sushi 20 is supported on a second lower portion 155 of a second cut surface 143 of an adjacent slice of sushi 20 to provide an overlapping or shingled configuration as shown in FIG. 3. The exceptions are the front and rearmost of rows 13, 17 of sushi slices 20. In the rearmost row 17, there is no further rearwardly adjacent row of sushi on which the first upper portion 150 of the rearmost row 17 can be supported. Hence, the rearmost prop 125 extends higher than the raised edge of the other props 105, 110, 115, 120. Specifically, the rearmost prop 125 has a higher front face 130. This rearmost front face 130 supports the first upper and lower portions 150, 145 of first cut surface 141 of the slices of sushi 20 in the rearmost row 17. Similarly, the frontmost row 13 of sushi slices 20 does not have any sushi slices 20 supported on lower portions 155 of their second cut surfaces 143.

As shown in FIG. 3, the slices of sushi are angled and supported such that an upper edge 160 of each slice of sushi 20 is positioned in close proximity to an underside 165 of the cover 30. The structure that enables this compact and aesthetically appealing package includes specific angles, spacing, and heights of elements of the tray 25 and cover 30. For example, the front face is disposed at an angle of more than 22.5 degrees upwardly and to the rear relative to a plane of the tray in a normally horizontal use position as shown at 170 in FIG. 3. Preferably angle 170 is in the range from 40 to 50 degrees. The angle 170 is for the purpose of providing an overlapping relation of the slices of sushi 20 resting on the props 105, 110, 115, 120, 125.

The rear face is disposed at an angle less than 65 degrees relative to the normally horizontal position of use as shown at 175 in FIG. 3. The angle 175 is preferably in the range from 45 to 50 degrees downwardly and to the rear. The rear faces 135 abut the bottom uncut edges 140 of the slices of sushi to hold the slices of sushi 20 against sliding downwardly generally in the plane of the slices of sushi 20. In this way, lower portions of respective slices of sushi are held in grooves 185, 190, 195, 200 defined by respective rear and front faces of adjacent wedge sectioned props 105, 110, 115, 120, 125. The height of the rear faces 135 of the props 105, 110, 115, 120 is selected to generally correspond to the thickness of sushi to be supported on the tray 25. In this way, an upper portion of the sushi slices does not sag much, if at all, below a plane defined by the front face 130. As the slices are made to stand up in a non-sagging manner by the props and the lower portions of the rows 15, 17 of sushi 20, the impression of an abundance of sushi is provided. This is a great improvement over the packaging of the past in which an impression of sparseness is invoked when the sushi 20 is placed in non-overlapping relation on a tray.

Another factor affecting the appearance is the spacing of the props 105, 110, 115, 120, 125, and thus the grooves 185, 190, 195, 200 defined between the props 105, 110, 115, 120, 125. The spacing between the grooves and props 205 is in the range from 1 to 2 times the height 210 of the intermediate props 110, 115, 120. Preferably the spacing 205 is less than or equal to 1 and % of the height 110 of the intermediate props 110, 115, 120. The combination of the angles of the faces 130, 135, and the spacing of the props determines the point at which the front and rear faces of respective props intersect. This relationship in combination with the size and thickness of the sushi slices 20 determines the height to which the upper edges 160 of the sushi 20 reaches in the packages 10. The cover is configured to reach a height 215 in the range from two to three times the height 220 of the outwardly protruding lip 90 of the tray 25. Preferably, the cover reaches a height 215 of substantially twice the height 220 of the outwardly protruding lip 90 of the tray 25 as shown in FIG. 4.

Advantageously, protrusions 45 are formed as further downward extensions of channels 230, 232 as shown in FIGS. 1B and 2. The channels 230, 232 run along lateral edges of the tray 25 and span all of the props 105, 110, 115, 120, 125, and are continuously at least as deep as said grooves 185, 190, 195, 200 between the props. The channels 230, 232 extend to a moderate depth in regions 235 substantially on the same plane as the deepest portions 240 of the grooves 185, 190, 195, 200. The channels 230, 232 are specifically for holding packets of soy sauce or other seasoning. Alternatively, one or more of the rows 13, 15, 17 of sushi 20 can be replaced by packets of seasonings.

Regions 235 on an upper surface 245 of the tray 25 correspond to portions 247 forming gaps 55 in the lower surface 250 of the tray 25. This is because the tray 25 and cover 30 are formed from sheets of polymeric material such as polyethylene terephthalate (PETE) that are thermo-formed in a contoured mold. As such, the upper and lower surfaces substantially follow the same contour. Use of the polyethylene terephthalate (PETE) material is an improvement over some materials used in the past including expanded polystyrene. PETE has the advantages of having a higher specific gravity and being stronger than the typical expanded polystyrene. The higher density PETE material is also more uniform in thickness. Therefore, the upper and lower surfaces better follow the same contour.

The contour of the tray 25 includes segmentation openings 255, 260 in the otherwise continuously inverted V-shaped central wedge sectioned props 115, 120. The segmentation openings 255, 260 are generally polyhedral shaped although they could be of any shape. The openings act as natural dividers of the props in the widthwise direction and are placed to leave the props 115, 120 intact in locations typically needed to support the slices of sushi 20. Preferably, two or more of the plurality of the props 110, 125 each span a major portion of a width of the tray, while two or more of the plurality of the props 115, 120 are segmented in a width direction by openings between portions of the props. In this way, portions of the front surfaces 130 of segmented props 115, 120 span only a minor portion of the width of the tray 25.

The openings 255, 260 have generally flat base walls 265, 270 respectively, that reach the moderate depth of the deepest portions 240 of the grooves 185, 190, 195, 200. As such the flat base walls 265, 270 are on the same plane as portions 235 of the channels 230, 232. The flat base plates 265, 270 are in the upper surface 245 of the tray and correspond to flat faces 275, 280 on the lower surface 250 of the tray 25. These flat faces 275, 280 are substantially on the same plane as the portions 247 of the lower surface 250 that forms gaps 55. The flat faces 275, 280 and the portions 247 provide a needed support and attachment surface for the paper label 60. Advantageously, ends 285, 290 can be attached to the tray and/or to each other in superposed relation with the flat faces 275, 280 as can be appreciated from viewing FIGS. 1B, 2, and 3.

As can be appreciated, respective apexes or crests 295, 297, and 299 are formed at intersections between respective front and rear surfaces 130, 135 of the props 110, 115, 120. The openings 255 lie completely surrounded by front surface 130 of prop 115. Openings 260, on the other hand, are only partially surrounded by the front surface 130 of prop 120. As shown in FIGS. 2 and 3, portions of the flat base walls 270 of openings 260 join the deepest portion 240 of the groove 195 in a continuous relation. The front to rear positioning of the segmentation openings is determined mainly by the need for alignment of the flat faces 275, 280 with the gap 55 of the tray and the uninterrupted portion 65 of the cover 30.

FIG. 6 shows alternative structure for the region VI encircled in FIG. 2. While the embodiment shown in FIGS. 2-4 is preferably made with four rows that fit two slices of sushi 20 on each row 13, 15, 17, alternative embodiments can be made with more and wider rows. One such alternative is exemplified by the number of rows and number of slices of sushi on each row in FIG. 1A. FIG. 6 provides specific structure to better support the increased numbers of rows and slices of sushi. The greater number and width of the rows calls for differently structured segmentation openings. As shown in FIG. 1A, the number of rows 13, 15, 17 is five. The different segmentation structure is shown in FIG. 6. For example, openings 300 are formed in the apex 305 of prop 310. Openings 315 are formed all the way through prop 320 in a front to rear direction. Openings 325 are formed in a minor portion of and are only partially surrounded by the front face 330 of prop 335. The remaining structure is substantially analogous to the embodiment described above. However, it is to be expressly understood that the openings 300, 315, 325 and their positions are exemplary and are not to be considered as limiting, except to the extent claimed.

FIG. 7 is a sectional view taken along lines VII-VII of FIG. 6 and illustrates the continuously flat base wall 340 formed by the openings 315, 325, and the groove 345 extending between the openings 315 and the openings 325 in the upper surface 350 of the tray 25. A corresponding flat face 355 on an opposite lower surface of the tray 25 is thus provided due to the thin sheet material from which the tray 25 is formed. Openings 300 have flat base walls 360 that create flat faces 365 on a lower surface 370 of the tray 25. As shown in FIG. 6, the openings 300 are relatively wide and the base walls 360 are also wide. The openings 315, 325 are correspondingly wide and the base wall 340 that they form is wide as well as long. The result is a relatively large total area of flat faces 355, 365 on the lower surface of the tray to which a label 60 can be attached in accordance with the description in the embodiment of FIG. 1B described above. Once again, the main criteria in positioning the openings 300, 315, and 325 is that they need to provide the flat faces 355, 365 in alignment with the gap 55 and the uninterrupted portion 65 for properly accommodating and attaching the label 60 as in the previously described embodiment. Also illustrated in FIG. 7 are the angles 170, 175 of the front and rear faces 380, 385 that are analogous to the embodiment described above.

As illustrated in FIG. 6, an additional intermediate level 390 can alternatively be provided between a depth of the base wall 340 and a depth of moderate depth regions 400. Accordingly, transition channels 395 are between the grooves 405 and the moderate depth region 400 of the Channels 410. In fact, any number of additional levels and depths can be provided and any intermediate transition surfaces can be added between the different levels of the upper surface. Such transitions and variations in levels can especially aid in channeling excess moisture or condensation away from the slices of sushi.

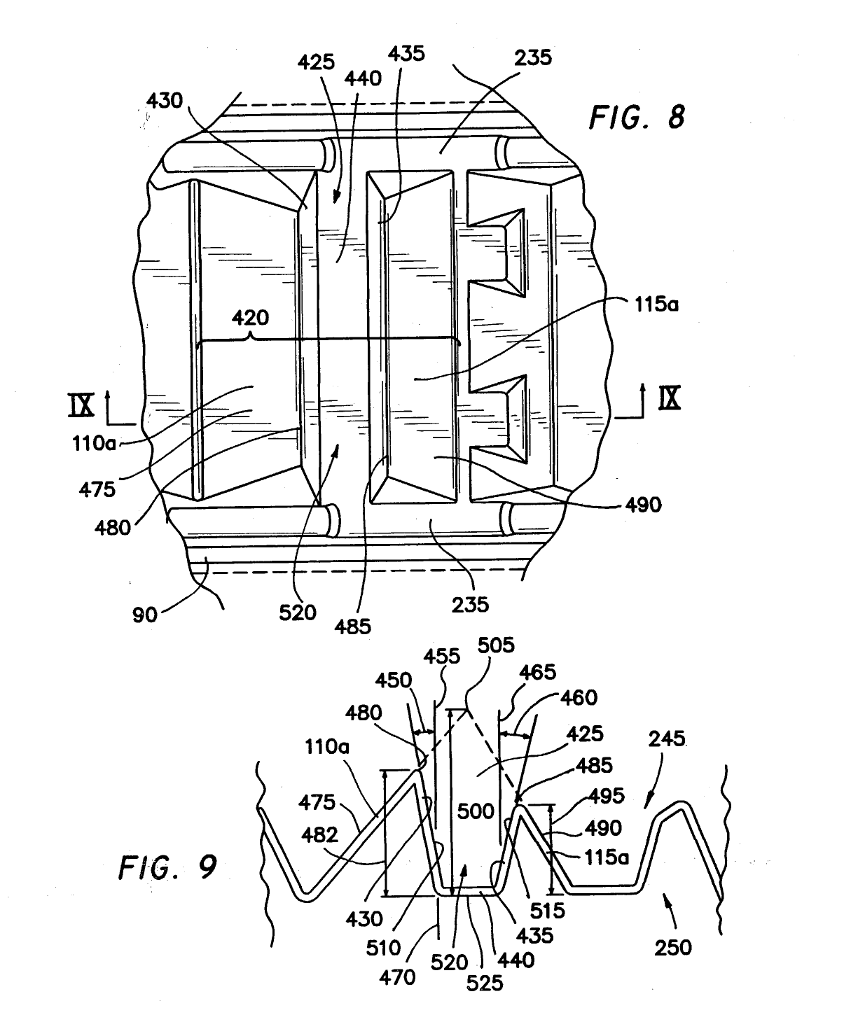

FIG. 8 is a view similar to FIG. 6 of a third embodiment of the region VI encircled in FIG. 2. The embodiment of FIG. 8 is very similar to the embodiment of FIG. 2. The tray 25 of FIG. 2 provides for 4 rows of sushi, (in the case with no props added or removed at the break lines 40). The region of tray 25 shown in FIG. 8 is different in that the props 110, 115 of FIG. 2 have been converted. Specifically, props 110, 115 have been replaced by first and second modified intermediate props 110a and 115a with an opening 425 extending between the modified props 110a and 115a. This opening 425 has a front wall 430, a rear wall 435, and a generally rectangular base wall 440. The rectangular base wall 440 has an upper surface 445 that is flat and generally contiguous with the moderate intermediate depth regions 235.

As shown in FIG. 9, the front wall 430 extends upwardly and to the front at an angle 450 in the range from approximately 3 to 25 degrees to a vertical plane 455. The rear wall 435 extends upwardly and to the rear at an angle 460 in the range from approximately 3 to 25 degrees relative to a vertical plane 465. The opening 425 is positioned slightly rearwardly of a front to back center 470 of the prop 420. In this way the front wall 430 of the opening 425 intersects the front face 475 of the prop 110a along a line 480. The line 480 has a height 482 greater than the height 220 of the outwardly extending lip 90. Providing the front face 475 in this configuration enables the front face 475 to support both of the upper and lower portions 150, 145 of the first cut surface 141 of the front row 13 of sushi 20 similar to the front face 130 of the rearmost prop 125 as described with respect to FIGS. 2 and 3 above.

The opening 425 extends downwardly from the line 480 to the rectangular base wall 440. The opening 425 also extends rearwardly to the rear wall 435. The rear wall 435 of the opening 425 intersects a rear face 490 of the prop 115a along a line 485. The line 485 of the intersection between the rear wall 435 and the rear face 490 is located at a predetermined position. A height 495 of the line 485 of the intersection is approximately equal to the height 210 of the next rearward prop 120. This height 495 is also approximately one half of a height 500 to which an apex 505 of the front surface 475 and the rear surface 490 would have reached with no opening 425 between the props 110a and 115a, as shown by dashed lines in FIG. 9.

The front wall 430 of the opening forms a rear face 510 of the modified first intermediate prop 110a. The rear wall 435 of the opening 420 forms a front face 515 of a modified second intermediate prop 115a. A modified row 520 is defined between the first and second modified props 110a, 115a. The modified row 520 is provided for holding packets 35 of soy sauce or other seasonings as described above. In this case, the seasoning packets 35 are to be positioned in the opening 425 between the rows 13, 15 of sushi. As such the modified row 520 for seasoning packets 35 replaces one of the sushi rows 15. Thus, the embodiment of FIG. 8 would reduce the number of rows 13, 15, 17 of sushi from 4 to 3.

The rear face 490 of the modified prop 110a is adapted to support the lower un-cut portion 140 of the sushi slices 20 supported thereon. It is to be understood that the position of the opening 425 defining the modified props 110a, 115a is to be taken by way of example and not by way of limitation. This opening 425 and the resulting modified row 520 could be positioned between any two adjacent props.

Locating the opening 425 as depicted in FIG. 8 has certain advantages. The result is a long rectangular flat face 525 on the lower surface 250 of the tray 25. A label 60 can be attached to the long rectangular flat surface 525 in accordance with the description in the embodiment of FIG. 1B described above. Providing the long side-to-side opening 425 between modified props 110a and 115a has the advantage of simultaneously providing the needed structure for aesthetically receiving condiment packets 35 on the upper surface 245 of the tray 25 and the flat face 525 on the lower surface 250 of the tray 25 for attaching the label 60. A main criterion for positioning the opening 425 is that the opening needs to provide the flat face 525 in alignment with the gap 55 and the uninterrupted portion 65 for properly accommodating and attaching the label 60 as in the previously described embodiments.

The embodiment of FIGS. 8 and 9 are otherwise similar to the embodiments of FIGS. 1A-5 described above.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the invention.

1. A sushi package comprising:
a tray generally defining a plane, the plane being generally horizontal in an orientation of use, the tray having:
an upper surface and a lower surface;
the upper surface comprising:
a plurality of wedge sectioned props each having at least one of a front surface and a rear surface,
said props extending to heights measured from a lowest point to a highest point of respective said props, the props extending axially from side to side;
said plurality of wedge sectioned props forming rows with a respective wedge sectioned prop between adjacent ones of said rows; and
said rows spaced from each other a distance less than or equal to 1½ of the height of the prop between the rows for presenting multiple rows of sushi in an overlapping and tilted display by propping lower portion of a first cut surface of a first slice of sushi on the upper surface of the tray and an upper portion of the first cut surface of the first slice of sushi on a lower portion of a second cut surface of a second slice of sushi.

2. The sushi package of claim 1, further comprising a transparent cover supported on the tray.

3. The sushi package of claim 2, the tray further comprising:
a front, a back, first lateral side, and a second lateral side;
the upper surface and the lower surface each extending between the front, back, and sides;
a raised edge extending along the front, back, and sides and surrounding a major portion of the upper surface; and
at least one channel extending longitudinally in a front to back direction between the props and the raised edge; and
the cover further comprising:
a front, a back, a first lateral side, and a second lateral side;
an upper surface and a lower surface each extending between the front, back, and sides;
said lower surface proximate to said slices of sushi to inhibit movement of said slices of sushi during storing and shipping; and
a downwardly protruding wall engaging the tray and supporting the cover on the tray to protect the slices of sushi supported on the props in a covered configuration.

4. The sushi package of claim 3, wherein at least one of the props extends higher than the raised edge.

5. The sushi package of claim 3, wherein:
the raised edge of the tray further comprises an outwardly extending lip; and
the downwardly protruding wall of the cover further comprises an outwardly protruding flange having an additional downwardly extending wall with an inwardly protruding tab for engaging under the lip of the tray when the cover is placed on the tray and forced together with the tray in a snap fit relation in the covered configuration.

6. The sushi package of claim 5, further comprising a serving configuration wherein:
the cover is inverted and placed below the tray;
the tray is inserted in the cover so that the downwardly protruding wall is oriented to protrude upwardly and surrounds the tray; and
the inwardly protruding tab engages over the lip of the tray when the tray and cover are forced together in a snap fit relation in the serving configuration.

7. The sushi package of claim 3, wherein the plurality of wedge sectioned props further comprise:
a front prop, a rear prop, and a plurality of intermediate props;
wherein the intermediate props have a height less than or equal to a height of the raised edge.

8. The sushi package of claim 7, wherein the downwardly protruding wall of the cover supports the cover in a covered configuration to extend to a position substantially twice a height of the tray.

9. The sushi package of claim 3, wherein:
the channel is a first channel adjacent to the first lateral side;
the upper surface of the tray further comprising a second channel adjacent to the second lateral side;
the first and second channels have recesses forming corresponding downward protrusions on the lower surface of the tray; and
the upper surface of the cover further comprises depressions for receiving corresponding downward protrusions on a lower surface of another tray.

10. The sushi package of claim 9, wherein:
the tray is one of a plurality of trays;
the cover is one of a plurality of covers; and
each of the plurality of trays matingly fits on top of each of the plurality of covers with the downwardly extending protrusions on the lower surfaces of the trays engaging in the depressions on the upper surfaces of the covers such that the trays and covers may be securely stacked in any order in their covered configurations.

11. The sushi package of claim 9, further comprising:
V-shaped grooves formed between respective said props; and
wherein the channels span all the props and are continuously at least as deep as the grooves between the props.

12. The sushi package of claim 1, wherein the front surfaces of the props are inclined upwardly and to the rear at an angle greater than 22.5 degrees relative to the plane of the tray.

13. The sushi package of claim 1, wherein:
two or more of the plurality of the props each span a major portion of a width of the tray; and
two or more of the plurality of the props are segmented in a width direction by openings between portions of the props.

14. The sushi package of claim 13, wherein:
the front and rear surfaces of respective props form and apex and intersect each other at the apex; and
at least one of the segmented props is segmented by recesses in the apex.

15. The sushi package of claim 13, wherein:
the front and rear surfaces of respective props form an apex and intersect each other at the apex; and
at least one of the segmented props is segmented by cutaway portions that leave openings in at least a base of the prop.

16. The sushi package of claim 13, further comprising:
V-shaped grooves defined between pairs of adjacent props; and
the openings extend to a depth substantially equal to the depth of the grooves.

17. The sushi package of claim 13, further comprising:
the openings defined by structure having sides and a generally flat bottom; and
the structure forming generally flat faces in the underside of the tray.

18. The sushi package of claim 17, further comprising:
a transparent cover supported on the tray;
a paper label circumscribing the tray and the cover; and
the paper label being attached to the generally flat faces in order to aid in holding the cover on the tray.

19. The sushi package of claim 17 wherein the rear surface of respective props is inclined downwardly and to the rear at an angle less than 65 degrees relative to the plane of the tray.

20. The sushi package of claim 1, wherein:
the front surface of respective props is inclined upwardly and to the rear in the range from 40 to 50 degrees relative to the plane of the tray; and
the rear surface of respective props is inclined downwardly and to the rear in the range from 45 to 50 degrees relative to the plane of the tray.

21. The sushi tray of claim 1, wherein:
the front surface of a majority of the props is inclined upwardly and to the rear in the range from 40 to 50 degrees relative to the plane of the tray;
the rear surface of a majority of the props is inclined downwardly and to the rear in the range from 45 to 50 degrees relative to the plane of the tray;
at least one of the front surfaces is inclined upwardly and to the rear in the range from 75 to 97 degrees relative to the plane of the tray; and
at least one of the rear surfaces is inclined downwardly and to the rear in the range from 75 to 97 degrees relative to the plane of the tray.

22. The sushi tray of claim 21, wherein the at least one front surface and the at least one rear surface face each other and form an opening adapted to receive seasoning packets.

23. A method of displaying, comprising:
propping a lower portion of a first cut surface of a first slice of sushi on a surface of a tray and an upper portion of the first cut surface of the first slice of sushi on a lower portion of a second cut surface of a second slice of sushi; and
covering the first and second slices of sushi with a transparent cover proximate to respective upper edges of the slices of sushi so that little or no movement of the sushi occurs during storing and shipping.

24. The method of displaying as recited in claim 23, wherein:
the first slice of sushi is one of a plurality of similar slices of sushi on a first row; and
the second slice of sushi is one of a plurality of similar slices of sushi on a second row.

25. The method of displaying as recited in claim 24, wherein the first and second rows are first and second rows of four or more rows.

26. The method of displaying as recited in claim 24, wherein the first and second rows are laterally extending rows, the method further comprising supporting at least one seasoning packet laterally outward of the rows.

27. The method of displaying as recited in claim 24, wherein the first and second rows are laterally extending rows, the method further comprising supporting at least one seasoning packet between the laterally extending first and second rows of sushi.

28. The method of displaying as recited in claim 23, further comprising supporting generally ½ of the cut surface of the first slice of sushi on the second portion of the second slice of sushi.

29. The method of displaying as recited in claim 23, further comprising:
covering the tray with the cover, and
wherein the cover has an upper-most inner surface at a position relative to the lower-most surface of the tray, said position being in the range from two to three times the height of the props.

30. The method of displaying as recited in claim 23, further comprising:
propping the first cut surface of the first slice of sushi in a tray at an angle greater than 22.5 degrees upwardly and to the rear relative to a normally horizontal plane of the tray;
supporting an uncut base portion of the first slice of sushi on a surface of the tray having an angle less than 65 degrees relative to the plane; and
covering the first and second slices of sushi with a transparent cover proximate to respective upper edges of the slices of sushi.

31. The method of displaying of claim 23, wherein the tray and cover form a first of a plurality of like packages and further comprising:
stacking the plurality of packages so that when a top package is removed the next subjacent package automatically displays the contents of the next package in like manner to the top package.

32. The method of displaying of claim 23, further comprising:
removing the cover;
inverting the cover;
inserting the tray into the cover; and
snap fitting the tray into the cover for a serving display configuration.

33. The method of displaying of claim 23, further comprising propping the first cut surface of the first slice of sushi in the tray at an angle in the range from 40 to 50 degrees upwardly to the rear relative to the plane of the tray.

34. A method of displaying sushi in a package, wherein the package comprises:
a tray generally defining a plane, the plane being generally horizontal in
an orientation of use, the tray having:
an upper surface and a lower surface;
the upper surface comprising:
a plurality of wedge sectioned props each having at least one of a front surface and a rear surface for presenting multiple rows each having a plurality of slices of sushi in an overlapping and tilted display configuration; and
a transparent cover supported on the tray in a covered configuration; and
the method comprising:
propping lower portions of first cut surfaces of a first plurality of slices of sushi on one of the front surfaces of one of the props, and upper portions of the first cut surfaces of the first plurality of slices of sushi on lower portions of second cut surfaces of a second plurality of slices of sushi; and
covering the first and second pluralities of slices of sushi with the transparent cover proximate to respective upper edges of the slices of sushi so that little or no movement of the sushi occurs during storing and shipping.
